(19) United States
(12) Patent Application Publication
(10) Pub. No.: US 2026/0031583 A1
(43) Pub. Date: Jan. 29, 2026

(54) CONNECTOR ASSEMBLY

(71) Applicants: Japan Aviation Electronics Industry, Ltd., Tokyo (JP); Yamaichi Electronics Co., Ltd., Tokyo (JP)

(72) Inventors: Masashi Tanaka, Tokyo (JP); Hiroaki Kuribayashi, Tokyo (JP); Keita Nozawa, Tokyo (JP); Toshiyasu Ito, Tokyo (JP); Yosuke Takai, Tokyo (JP); Masaaki Saito, Tokyo (JP)

(73) Assignees: Japan Aviation Electronics Industry, Ltd., Tokyo (JP); Yamaichi Electronics Co., Ltd., Tokyo (JP)

(21) Appl. No.: 19/237,314

(22) Filed: Jun. 13, 2025

(30) Foreign Application Priority Data
Jul. 24, 2024 (JP) 2024-118748

(51) Int. Cl. H01R 24/56

(52) U.S. Cl. CPC H01R 24/568

(57) ABSTRACT

A connector assembly in which ground paths between cables and a paddle card are formed and of which the size can be reduced is provided. A connector assembly includes a ground member including a plurality of partitioning members made of metal, each of which has a U-shape, and a metal plate to which the partitioning members are fixed. The ground member is configured such that the partitioning members are arranged at a pitch twice a predetermined pitch in a width direction of the connector assembly, so that partition walls of the partitioning members are arranged at the predetermined pitch in the width direction of the connector assembly. The ground shields are electrically connected to the ground member in a state where ground shields exposed from insulating films of the cables are disposed between the partition walls.

### INCORPORATION BY REFERENCE

This application is based upon and claims the benefit of priority from Japanese patent application No. 2024-118748, filed on Jul. 24, 2024, the disclosure of which is incorporated herein in its entirety by reference.

### BACKGROUND

The present disclosure relates to a connector assembly.

For example, as shown in FIG. 25, in a connector assembly 101 disclosed in Patent Literature 1, a carrier member 102 is electrically connected to a ground shield 103a of a cable 103 in a state where the ground shield 103a of the cable 103 is enclosed with a nest part 102a of the carrier member 102.

Further, in a state where the carrier member 102 is electrically connected to a plate 104a of a ground plane 104, a contact arm 104b of the ground plane 104 is electrically connected to a ground contact 105a of a paddle card 105.

In this way, a ground path extending from the ground shield 103a of the cable 103 to the ground contact 105a of the paddle card 105 is formed. Note that a carrier member 102 is formed of one metal plate, and each nest part 102a is formed by performing a punching process and thereby bending the one metal plate.
Patent Literature 1: U.S. Pat. No. 9,748,703

### SUMMARY

In the connector assembly 101 disclosed in Patent Literature 1, in order to unfold the nest parts 102a corresponding to the cables 103, which are arranged at a predetermined pitch, the nest parts 102a are staggered, and as a result, the positions where the nest parts 102a are connected to the ground are not uniformly arranged. As a result, there is a problem that it is difficult to reduce the size of the connector assembly 101.

An object of the present disclosure is to provide a connector assembly in which ground paths between cables and a paddle card are formed and of which the size can be reduced.

A connector assembly according to an aspect of the present disclosure is a connector assembly including a paddle card including a plurality of contacts, and a plurality of cables electrically connected to the plurality of contacts, in which the connector assembly further includes a ground member including:
a plurality of partitioning members made of metal, each of the plurality of partitioning members having a U-shape as viewed in an insertion and removal direction of the connector assembly; and
   a metal plate to which the partitioning members are fixed,
the ground member is configured such that the partitioning members are arranged at a pitch twice a predetermined pitch in a width direction of the connector assembly, so that the partition walls disposed on both sides of the partitioning members in the width direction of the connector assembly are arranged at the predetermined pitch in the width direction of the connector assembly,
each of the cables includes an inner conductor electrically connected to a contact of the paddle card, a dielectric covering the inner conductor, a ground shield covering the dielectric, and an insulating film covering the ground shield, and
the ground shield is electrically connected to the ground member in a state where a part of the ground shield exposed from the insulating film in the cable is disposed between the partition walls.

A connector assembly according to an aspect of the present disclosure is a connector assembly including a paddle card including a plurality of contacts, and a plurality of cables electrically connected to the plurality of contacts, in which the connector assembly further includes a ground member including:
a plurality of partitioning members made of metal, each of the plurality of partitioning members having a U-shape as viewed in an insertion and removal direction of the connector assembly; and
a metal member including a flat part to which the partitioning members are fixed, the metal member being a cut article or a molded article made of metal,
the ground member is configured such that the partitioning members are arranged at a pitch twice a predetermined pitch in a width direction of the connector assembly, so that the partition walls disposed on both sides of the partitioning members in the width direction of the connector assembly are arranged at the predetermined pitch in the width direction of the connector assembly,
each of the cables includes an inner conductor electrically connected to a contact of the paddle card, a dielectric covering the inner conductor, a ground shield covering the dielectric, and an insulating film covering the ground shield, and
the ground shield is electrically connected to the ground member in a state where a part of the ground shield exposed from the insulating film in the cable is disposed between the partition walls.

According to the present disclosure, it is possible to provide a connector assembly in which ground paths between cables and a paddle card are formed and of which the size can be reduced.

The above and other objects, features and advantages of the present disclosure will become more fully understood from the detailed description given hereinbelow and the accompanying drawings.

### BRIEF DESCRIPTION OF DRAWINGS

FIG. 1 is a perspective view of a connector assembly according to a first embodiment viewed from the Z-axis positive side;

FIG. 2 is an exploded perspective view of the connector assembly according to the first embodiment viewed from the Z-axis positive side;

FIG. 3 is a plan view of the connector assembly according to the first embodiment viewed from the Z-axis positive side, in which a housing and a frame are omitted (i.e., are not drawn);

FIG. 4 is a cross-sectional view taken along a line IV-IV in FIG. 3;

FIG. 5 is a perspective view of the connector assembly according to the first embodiment viewed from the Z-axis positive side, in which the housing and the frame are omitted (i.e., are not drawn);

FIG. 6 is a perspective view of the connector assembly according to the first embodiment viewed from the Z-axis negative side, in which the housing and the frame are omitted (i.e., are not drawn);

FIG. 7 is a perspective view of a paddle card and a ground member of the connector assembly according to the first embodiment viewed from the Z-axis positive side;

FIG. 8 is an exploded perspective view of the paddle card and the ground member of the connector assembly according to the first embodiment viewed from the Z-axis positive side;

FIG. 9 is a perspective view of a representative first partitioning member in the connector assembly according to the first embodiment viewed from the Z-axis positive side;

FIG. 10 is a perspective view of the representative first partitioning member in the connector assembly according to the first embodiment viewed from the Z-axis negative side;

FIG. 11 is a perspective view of a representative second partitioning member in the connector assembly according to the first embodiment viewed from the Z-axis positive side;

FIG. 12 is a perspective view of the periphery of the first partitioning member in the connector assembly according to the first embodiment viewed from the Z-axis positive side;

FIG. 13 is an enlarged plan view of the periphery of the first partitioning member in the connector assembly according to the first embodiment viewed from the Z-axis positive side;

FIG. 14 is a perspective view of a connector assembly according to a second embodiment viewed from the Z-axis positive side;

FIG. 15 is a perspective view of the connector assembly according to the second embodiment viewed from the Z-axis positive side, in which a housing and a frame are omitted (i.e., are not drawn);

FIG. 16 is a perspective view of a paddle card and a ground member in the connector assembly according to the second embodiment viewed from the Z-axis positive side;

FIG. 17 is an exploded perspective view of the paddle card and the ground member in the connector assembly according to the second embodiment viewed from the Z-axis positive side;

FIG. 18 is a perspective view of a representative first partitioning member of the ground member in the connector assembly according to the second embodiment viewed from the Z-axis positive side;

FIG. 19 is another perspective view of the representative first partitioning member of the ground member in the connector assembly according to the second embodiment viewed from the Z-axis positive side;

FIG. 20 is a perspective view of a representative second partitioning member in the connector assembly according to the second embodiment viewed from the Z-axis positive side;

FIG. 21 is a perspective view of a paddle card and a ground member in a connector assembly according to a third embodiment viewed from the Z-axis positive side;

FIG. 22 is an exploded perspective view of the paddle card and the ground member in the connector assembly according to the third embodiment viewed from the Z-axis positive side;

FIG. 23 is a perspective view of a partitioning member of a ground member according to the third embodiment viewed from the Z-axis positive side;

FIG. 24 is another perspective view of the partitioning member of the ground member according to the third embodiment viewed from the Z-axis positive side; and

FIG. 25 shows FIG. 8B of Patent Literature 1.

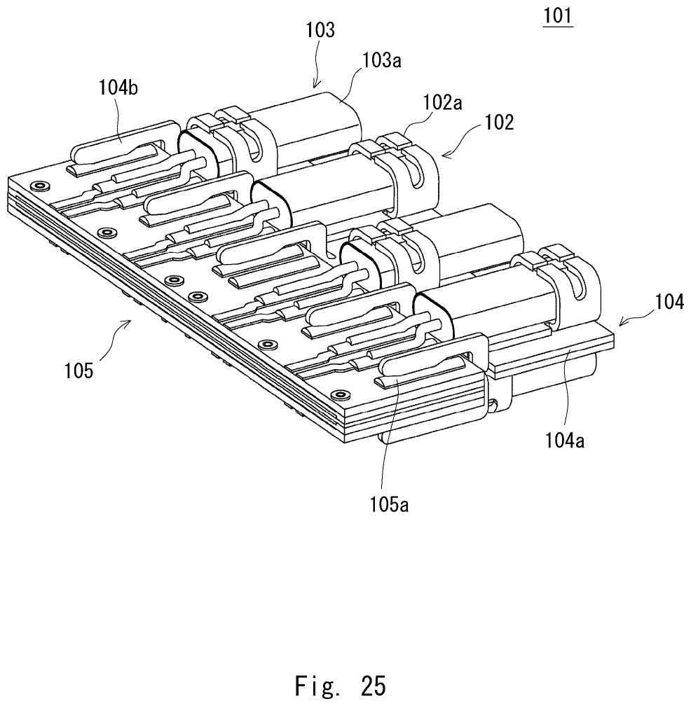

### DESCRIPTION OF EMBODIMENTS

Specific embodiments to which the present disclosure is applied will be described hereinafter in detail with reference to the drawings. However, the present disclosure is not limited to the below-shown embodiments. Further, for clarifying the explanation, the following description and drawings are simplified as appropriate.

### First Embodiment

A connector assembly according to this embodiment is suitably used, for example, as a jumper connector for electrically connecting a connector provided on a first substrate to a connector provided on a second substrate, both of which are provided in a server or the like.

Note the following description is given by using a three-dimensional (XYZ) coordinate system to clarify the explanation. Note that the X-axis direction is the insertion and removal direction of the connector assembly; the Y-axis direction is the width direction of the connector assembly; and the Z-axis direction is the thickness direction of the connector assembly.

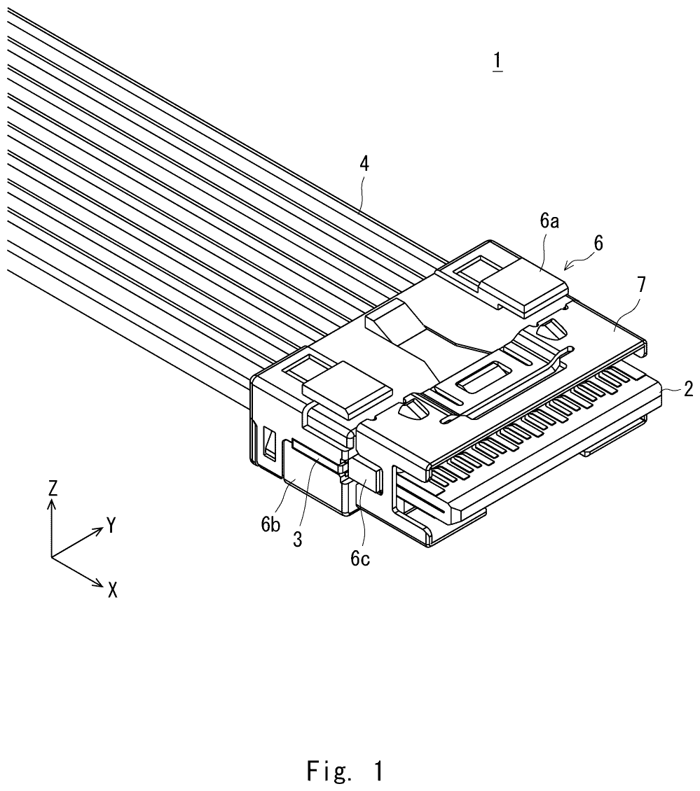

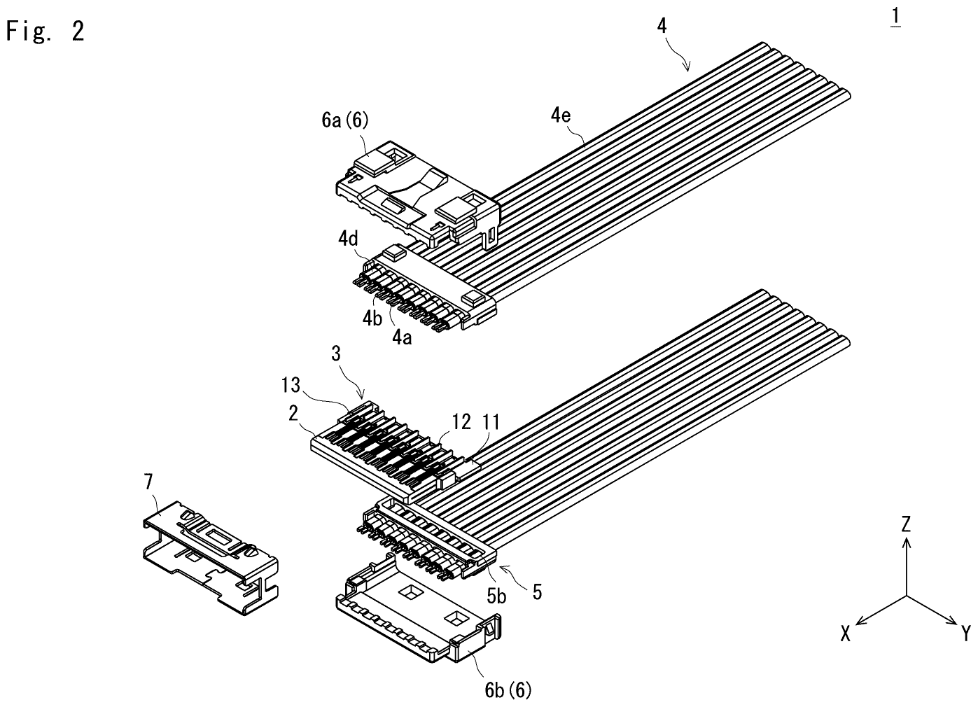

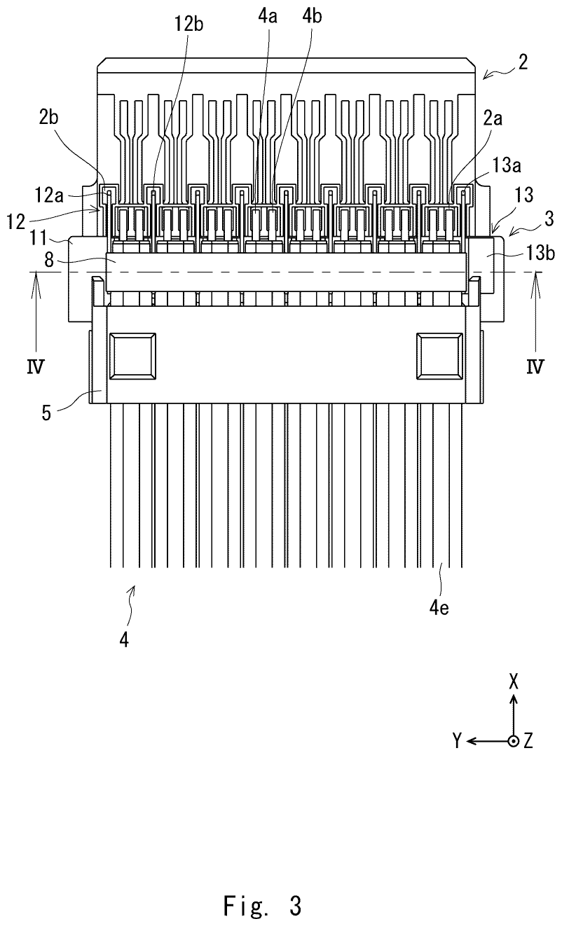

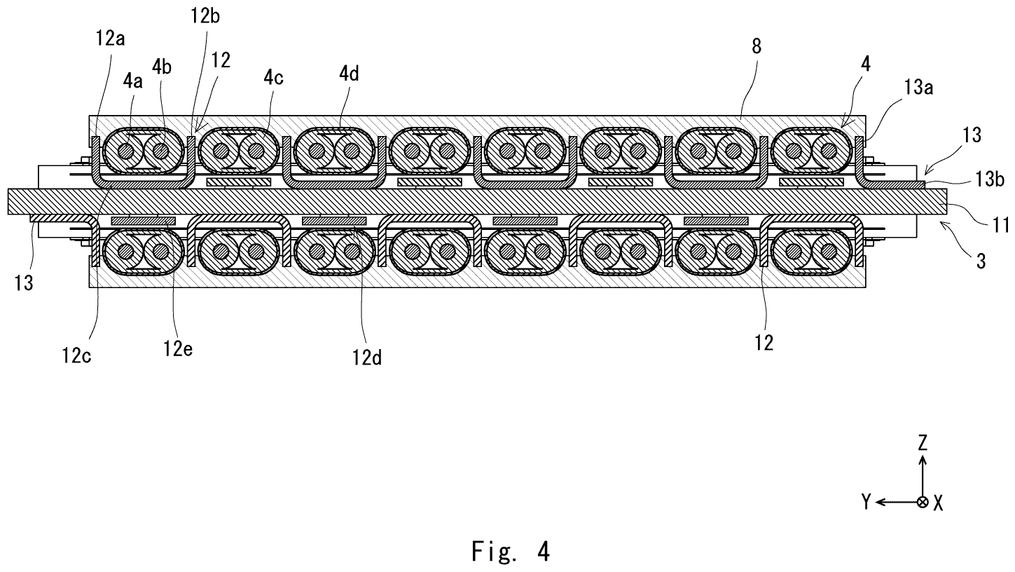

FIG. 1 is a perspective view of a connector assembly according to this embodiment viewed from the Z-axis positive side. FIG. 2 is an exploded perspective view of the connector assembly according to this embodiment viewed from the Z-axis positive side. FIG. 3 is a plan view of the connector assembly according to this embodiment viewed from the Z-axis positive side, in which a housing and a frame are omitted (i.e., are not drawn). FIG. 4 is a cross-sectional view taken along a line IV-IV in FIG. 3.

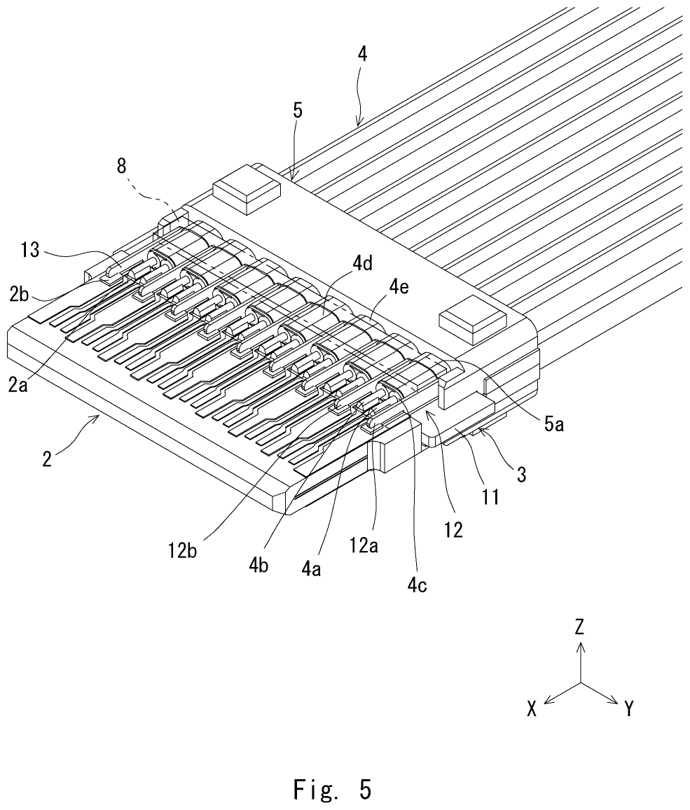

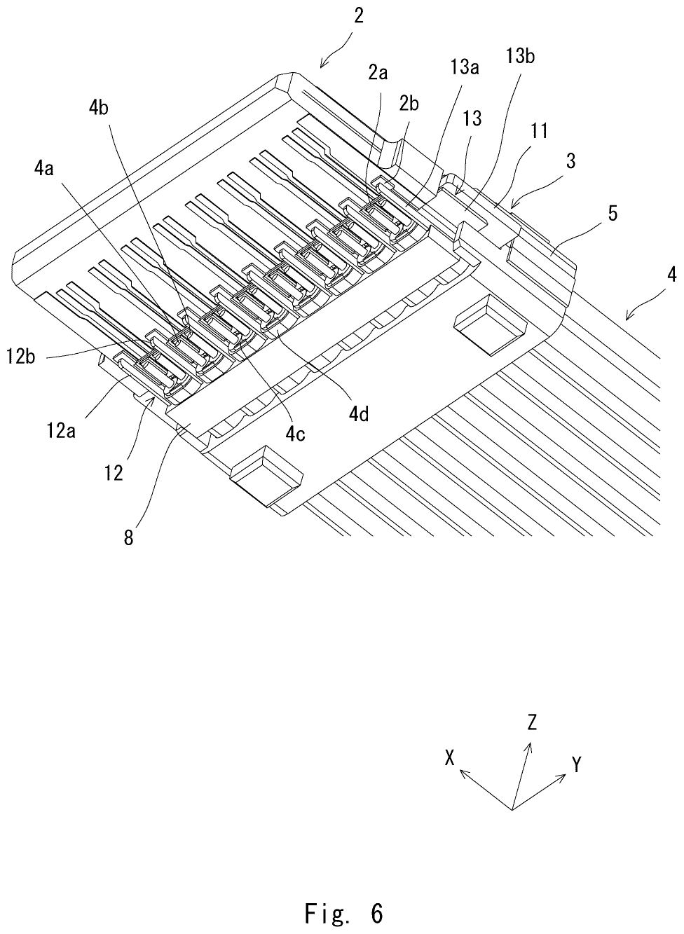

FIG. 5 is a perspective view of the connector assembly according to this embodiment viewed from the Z-axis positive side, in which the housing and the frame are omitted (i.e., are not drawn). FIG. 6 is a perspective view of the connector assembly according to this embodiment viewed from the Z-axis negative side, in which the housing and the frame are omitted (i.e., are not drawn).

As shown in FIGS. 1 to 4, the connector assembly 1 includes a paddle card 2, a ground member 3, cables 4, a locator 5, a housing 6, and a frame 7. As shown in FIGS. 5 and 6, the paddle card 2 includes signal contacts 2a and ground contacts 2b provided on the surface of a multilayered substrate on the Z-axis positive side and on the surface thereof on the Z-axis negative side.

Note that, as shown in FIG. 3, the ground contacts 2b are preferably arranged so that, for example, the signal contacts 2a are interposed therebetween in the Y-axis direction. Further, for example, both the signal contacts 2a and the ground contacts 2b are preferably arranged side by side in the Y-axis direction. That is, the signal contacts 2a are preferably arranged at roughly the same position in the X-axis direction, and the ground contacts 2b are also preferably arranged at roughly the same position in the X-axis direction.

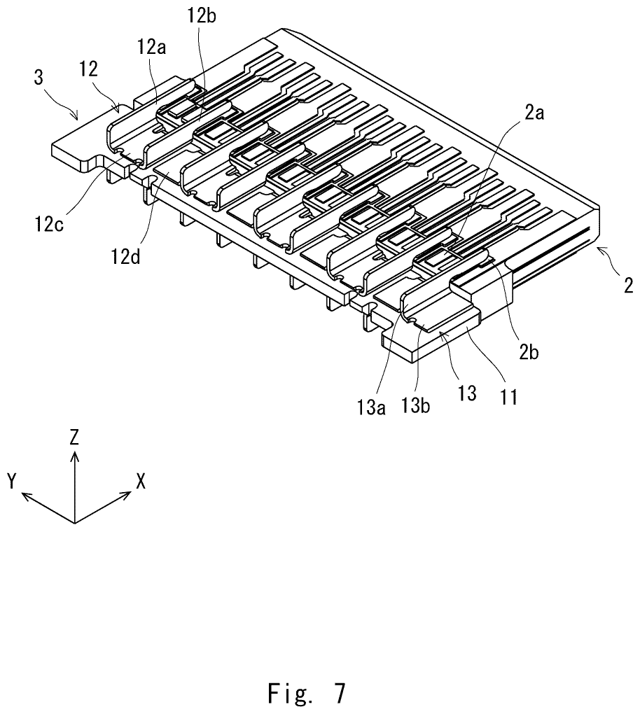

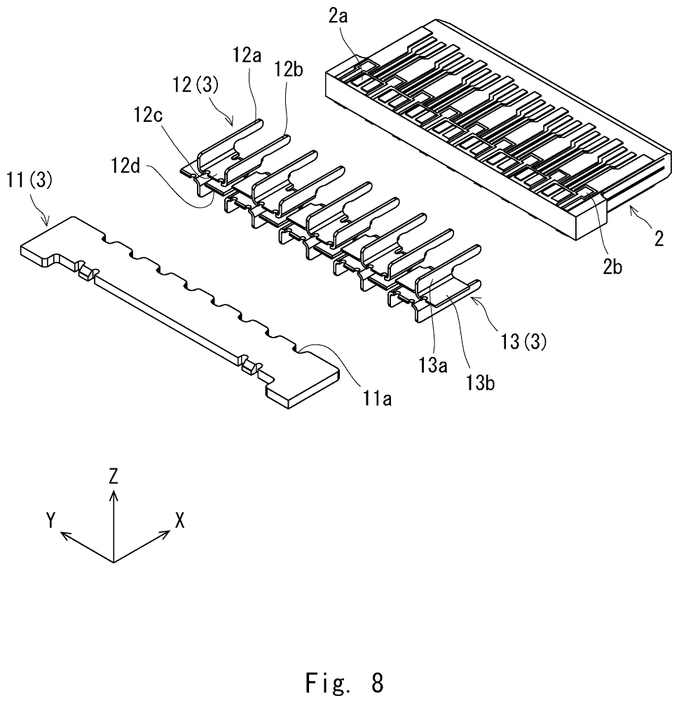

FIG. 7 is a perspective view of the paddle card and the ground member in the connector assembly according to this embodiment viewed from the Z-axis positive side. FIG. 8 is an exploded perspective view of the paddle card and the ground member in the connector assembly according to this embodiment viewed from the Z-axis positive side.

As shown in FIGS. 7 and 8, the ground member 3 is disposed on the X-axis negative side of the paddle card 2. The ground member 3 includes a metal plate 11, first partitioning members 12, and second partitioning members 13. The metal plate 11 is a plate member made of metal and disposed roughly parallel to the XY-plane, and preferably has, for example, a roughly rectangular shape which is long in the Y-axis direction as viewed from the Z-axis direction.

For example, as shown in FIG. 8, at the end of the metal plate 11 on the X-axis positive side, recesses 11a are preferably formed at a predetermined pitch in the Y-axis direction. In this embodiment, for example, an even number of recesses 11a are arranged in the Y-axis direction according to the number of cables 4 arranged side by side in the Y-axis direction. Note that, for example, the predetermined pitch is preferably slightly larger than the width of the cable 4 in the Y-axis direction.

As shown in FIGS. 3 and 4, the first and second partitioning members 12 and 13 partition the space in which the cables 4 are arranged into a plurality of sections. The first and second partitioning members 12 and 13 are arranged on both the Z-axis positive side and the Z-axis negative side of the metal plate 11.

Note that as shown in FIGS. 5 and 6, the first and second partitioning members 12 and 13 disposed on the Z-axis positive side of the metal plate 11 and the first and second partitioning members 12 and 13 disposed on the Z-axis negative side of the metal plate 11 are in a point-symmetric relationship with an axis that passes through the center of the connector assembly 1 in the Y-axis direction and is parallel to the X-axis being the axis of symmetry. Therefore, the shapes and arrangements of the first and second partitioning members 12 and 13 arranged on the Z-axis positive side of the metal plate 11 will be described hereinafter as a representative example.

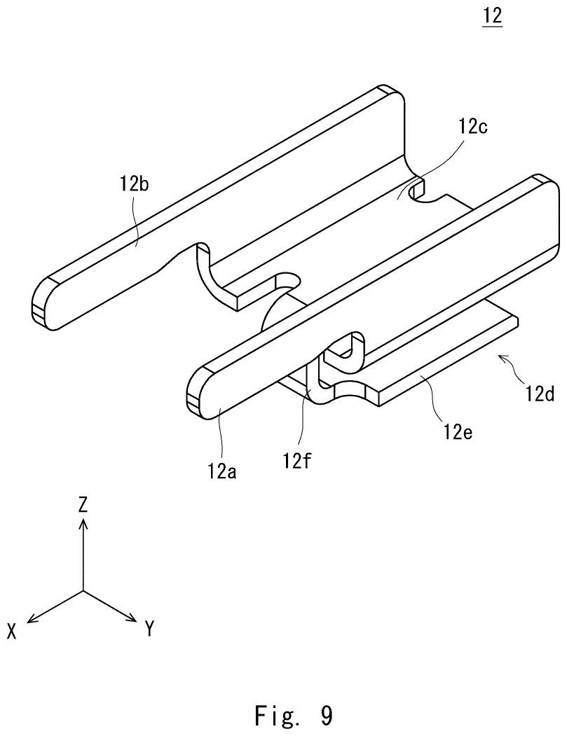

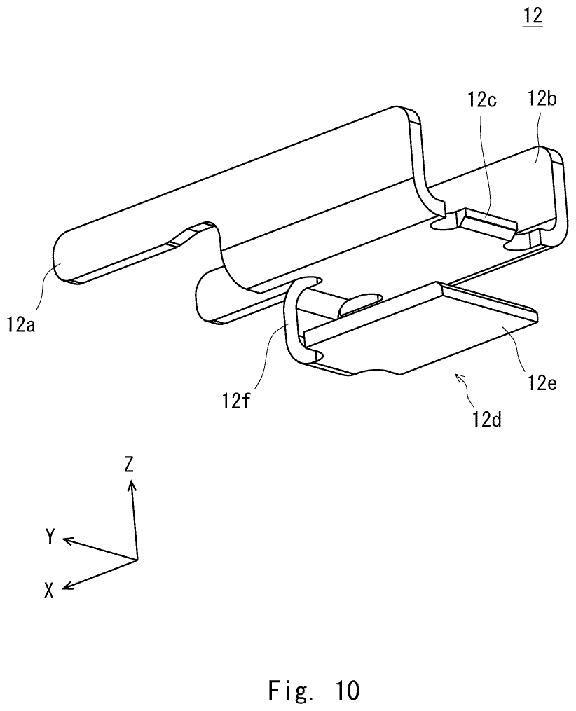

FIG. 9 is a perspective view of a representative first partitioning member in the connector assembly according to this embodiment viewed from the Z-axis positive side. FIG. 10 is a perspective view of the representative first partitioning member in the connector assembly according to this embodiment viewed from the Z-axis negative side. The first partitioning member 12 (i.e., each of the first partitioning members 12) is formed of a conductive member such as metal.

As shown in FIGS. 9 and 10, the first partitioning member 12 includes a first partition wall 12a, a second partition wall 12b, a flat part 12c, and a fixing part 12d. The first partition wall 12a is a plate member disposed roughly parallel to the XZ-plane, and preferably has, for example, a roughly rectangular shape which is long in the X-axis direction as viewed in the Y-axis direction. For example, the height of the first partition wall 12a in the Z-axis direction is preferably slightly shorter than the height of the cable 4 in the Z-axis direction.

As shown in FIGS. 9 and 10, the second partition wall 12b has a shape roughly identical to that of the first partition wall 12a. The second partition wall 12b is disposed on the Y-axis negative side of the first partition wall 12a, and overlaps the first partition wall 12a as viewed in the Y-axis direction. Note that the distance between the surface of the first partition wall 12a on the Y-axis negative side and the surface of the second partition wall 12b on the Y-axis positive side is preferably slightly larger than the width of the cable 4 in the Y-axis direction.

As shown in FIGS. 9 and 10, the flat part 12c connects the end of the first partition wall 12a on the Z-axis negative side and on the X-axis negative side with the end of the second partition wall 12b on the Z-axis negative side and on the X-axis negative side.

Therefore, as shown in FIGS. 9 and 10, the first partitioning member 12 has basically a roughly U-shape as viewed in the X-axis direction. Further, the end of the first partition wall 12a on the X-axis positive side and the end of the second partition wall 12b on the X-axis positive side project from the flat part 12c toward the X-axis positive side. The flat part 12c is a plate member disposed roughly parallel to the XY-plane, and preferably has, for example, a roughly rectangular shape as viewed in the Z-axis direction.

As shown in FIGS. 9 and 10, the fixing part 12d includes, for example, a flat part 12c, a connection part 12f which is bent about 90° from the end of the flat part 12c on the X-axis positive side toward the Z-axis negative side, and a flat part 12e which is bent about 90° from the end of the connection part 12f toward the X-axis negative side and disposed roughly parallel to the flat part 12c. The fixing part 12d has, for example, such a shape that the metal plate 11 can be interposed, and has a roughly U-shape as viewed in the Y-axis direction. The flat part 12e is a plate member disposed roughly parallel to the XY-plane, and preferably has, for example, a roughly rectangular shape as viewed in the Z-axis direction.

As shown in FIGS. 9 and 10, the flat part 12e is disposed on the Z-axis negative side of the flat part 12c, and overlaps the flat part 12c as viewed in the Z-axis direction. The outer shape of the flat part 12e is smaller than that of the flat part 12c. Further, the distance between the end of the flat part 12c on the Z-axis negative side and the end of the flat part 12e on the Z-axis positive side in the Z-axis direction is roughly equal to the thickness of the metal plate 11 in the Z-axis direction.

As shown in FIGS. 9 and 10, the connection part 12f connects the end of the flat part 12c on the X-axis positive side with the end of the flat part 12e on the X-axis positive side. The connection part 12f extends in the Z-axis direction and preferably has, for example, a roughly rectangular shape as viewed in the X-axis direction. Further, the width of the connection part 12f in the Y-axis direction is preferably shorter than the width of the flat part 12e on the Y-axis direction and roughly equal to the width of the recess 11a of the metal plate 11 in the Y-axis direction.

In the state where the first partition walls 12a, the second partition walls 12b, and the flat parts 12c of the fixing parts 12d of the first partitioning members 12 are disposed on the Z-axis positive side of the flat parts 12e of the fixing parts 12d as described above, for example, as shown in FIGS. 7 and 8, the connection parts 12f of the fixing parts 12d are inserted from the X-axis positive side into, among the recesses 11a of the metal plate 11, the odd-numbered recesses 11a counted from the Y-axis positive side, and the metal plate 11 is interposed between the flat parts 12c of the fixing parts 12d and the flat parts 12e.

As a result, as shown in FIG. 7, the first partitioning members 12 are electrically connected and fixed to the metal plate 11 in the state where the first partition walls 12a, the second partition walls 12b, and the flat parts 12c of the first partitioning members 12 are disposed on the Z-axis positive side of the metal plate 11.

Note that as shown in FIG. 4, the first partitioning members 12 are arranged at a pitch twice the predetermined pitch in the Y-axis direction, and the first and second partition walls 12a and 12b are arranged at a predetermined pitch in a repeated manner in the Y-axis direction.

Further, as shown in FIG. 7, the first and second partition walls 12a and 12b project beyond the metal plate 11 toward the X-axis positive side, and the ends of the first and second partition walls 12a and 12b on the X-axis positive side are electrically connected to the ground contacts 2b provided on the surface of the paddle card 2 on the Z-axis positive side.

Note that as described above, the first and second partitioning members 12 and 13 disposed on the Z-axis positive side of the metal plate 11 and the first and second partitioning members 12 and 13 disposed on the Z-axis negative side of the metal plate 11 are in the point-symmetric relationship.

Therefore, as shown in FIG. 4, as viewed in the X-axis direction, the first partitioning member 12 disposed on the Z-axis positive side of the metal plate 11 and the first partitioning member 12 disposed on the Z-axis negative side of the metal plate 11 are staggered, i.e., alternately disposed, in the Y-axis direction.

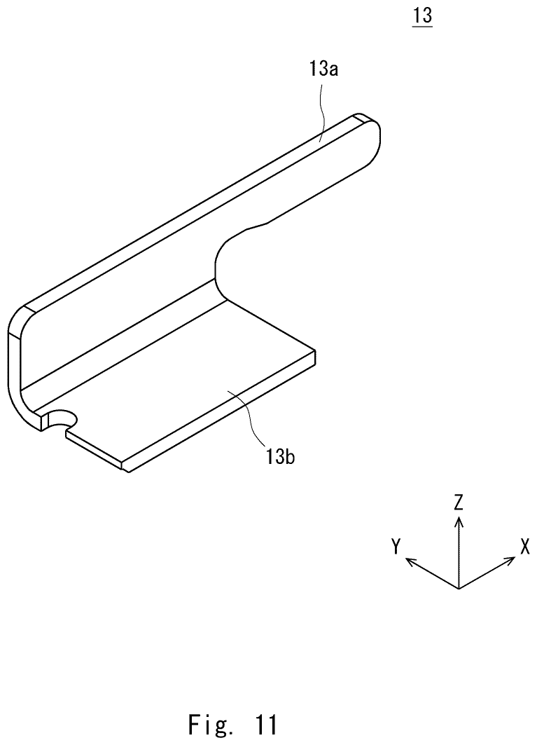

FIG. 11 is a perspective view of a representative second partitioning member in the connector assembly according to this embodiment viewed from the Z-axis positive side. As shown in FIG. 11, the second partitioning member 13 (i.e., each of the second partitioning members 13) includes a partition wall 13a and a flat part 13b. The partition wall 13a has a shape roughly identical to that of the first partition wall 12a of the first partitioning member 12.

As shown in FIG. 11, the flat part 13b is an end part of the partition wall 13a on the Z-axis negative side and projects from the end part thereof on the X-axis negative side toward the Y-axis negative side. The flat part 13b is a plate member disposed roughly parallel to the XY-plane, and preferably has, for example, a roughly rectangular shape as viewed in the Z-axis direction.

In the state where the partition walls 13a of the second partitioning members 13 project from the flat parts 13b toward the Z-axis positive side as described above, as shown in FIGS. 7 and 8, on the Z-axis positive side of the metal plate 11, the partition walls 13a of the second partitioning members 13 are disposed on the Y-axis negative side of the corresponding second partition walls 12b of the first partitioning members 12 on the Y-axis negative side with a space equivalent to the predetermined pitch therebetween.

Further, as shown in FIG. 7, the flat parts 13b of the second partitioning members 13 are electrically connected and fixed to the surface of the metal plate 11 on the Z-axis positive side. Note that as shown in FIG. 7, the partition walls 13a of the second partitioning members 13 project beyond the metal plate 11 toward the X-axis positive side, and the ends of the partition walls 13a on the X-axis positive side are electrically connected to the ground contacts 2b provided on the surface of the paddle card 2 on the Z-axis positive side.

In this way, as shown in FIGS. 3 and 5, on the Z-axis positive side of the metal plate 11, the first partition wall 12a of the first partitioning members 12, the second partition wall 12b of the first partitioning members 12, and the partition walls 13a of the second partitioning members 13 are arranged at the predetermined pitch in the Y-axis direction.

Further, as shown in FIG. 6, on the Z-axis negative side of the metal plate 11, the first partition wall 12a of the first partitioning members 12, the second partition wall 12b of the first partitioning members 12, and the partition walls 13a of the second partitioning members 13 are also arranged at the predetermined pitch in the Y-axis direction.

The cables 4 are arranged on both the Z-axis positive side and the Z-axis negative side of the metal plate 11. Note that the cables 4 arranged on the Z-axis positive side of the metal plate 11 and the cables 4 arranged on the Z-axis negative side of the metal plate 11 are in a point-symmetric relationship with an axis that passes through the center of the connector assembly 1 in the Y-axis direction and is parallel to the X-axis being the axis of symmetry. Therefore, the shapes and arrangements of the cables 4 arranged on the Z-axis positive side of the metal plate 11 will be described hereinafter as a representative example.

The cable 4 (i.e., each of the cables 4) is, for example, a Twinax cable. As shown in FIG. 4, the cable 4 includes a first inner conductor 4a, a second inner conductor 4b, a dielectric 4c, a ground shield 4d, and an insulating film 4e.

The first and second inner conductors 4a and 4b preferably form, for example, a pair of differential signal lines. As shown in FIG. 4, the dielectric 4c covers the first and second inner conductors 4a and 4b. Note that the first and second inner conductors 4a and 4b preferably project beyond the dielectric 4c toward the X-axis positive side by lengths roughly equal to each other.

The ground shield 4d covers the dielectric 4c. The insulating film 4e covers the ground shield 4d. Note that, for example, as shown in FIG. 5, the end of the insulating film 4e on the X-axis positive side is stripped off, so that the ground shield 4d is exposed from the insulating film 4e. Note that although the ground shield 4d is exposed by stripping off the entire circumference of the end of the insulating film 4e on the X-axis positive side in the example shown in FIG. 5 and the like, only a part of the circumference of the insulating film 4e may be stripped off (peeled off), so that, for example, only a part of the circumference of the ground shield 4d on the Z-axis positive side or on the Z-axis negative side may be exposed. In short, it is preferred that an arbitrary part of the insulating film 4e disposed on the X-axis positive side of the ends of the first and second partition walls 12a and 12b of the first partitioning member 12 on the X-axis negative side in the cables 4 is stripped off.

As shown in FIG. 5, the cables 4 are disposed between the first and second partition walls 12a and 12b of the first partitioning members 12, and between the second partition walls 12b of the first partitioning members 12 and the partition walls 13a of the second partitioning members 13 on the Z-axis positive side of the metal plate 11.

Further, as shown in FIGS. 3 and 5, the ends of the first and second inner conductors 4a and 4b of the cables 4 on the X-axis positive side are electrically connected to the signal contacts 2a provided on the surface of the paddle card 2 on the Z-axis positive side.

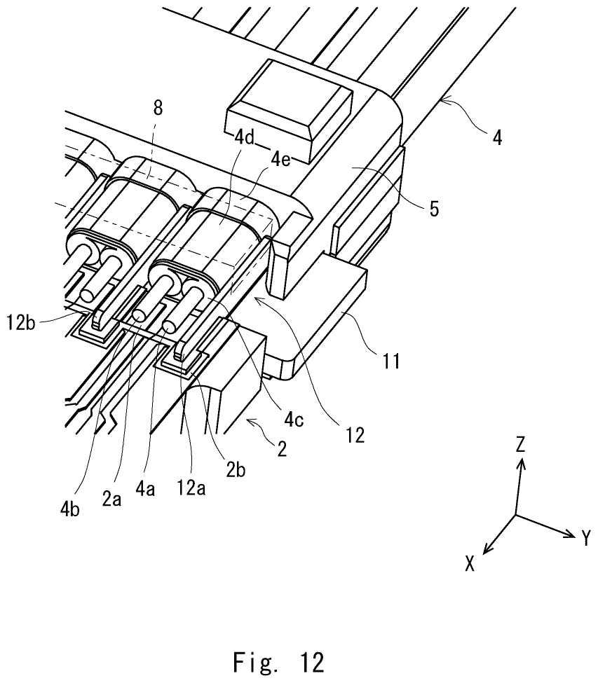

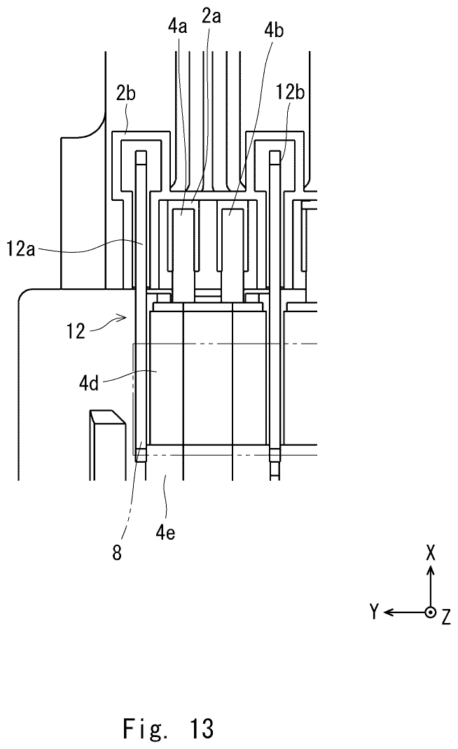

FIG. 12 is a perspective view of the periphery of the first partitioning member in the connector assembly according to this embodiment viewed from the Z-axis positive side. FIG. 13 is an enlarged plan view of the periphery of the first partitioning member in the connector assembly according to this embodiment viewed from the Z-axis positive side.

For example, as described above, the first partition wall 12a of the first partitioning members 12, the second partition wall 12b of the first partitioning members 12, and the partition walls 13a of the second partitioning members 13 are arranged at the predetermined pitch in the Y-axis direction. Therefore, as shown in FIGS. 12 and 13, the position of the cable 4 in the Y-axis direction is determined by the first and second partition walls 12a and 12b of the first partitioning member 12, or by the second partition wall 12b of the first partitioning member 12 and the partition wall 13a of the second partitioning member 13.

In this way, the cable 4 can be easily positioned, and the ends of the first and second inner conductors 4a and 4b of the cable 4 on the X-axis positive side can be easily electrically connected to the signal contacts 2a of the paddle card 2.

Note that as shown in FIG. 5, as viewed in the Y-axis direction, the first and second partition walls 12a and 12b of the first partitioning members 12 and the partition walls 13a of the second partitioning members 13 cover the cables 4 from the position on the X-axis negative side of the parts of the ground shields 4d exposed from the insulating films 4e of the cables 4 to the position beyond, on the X-axis positive side, the ends of the first and second inner conductors 4a and 4b of the cables 4 on the X-axis positive side. That is, the first and second partition walls 12a and 12b of the first partitioning member 12 and the partition wall 13a of the second partitioning member 13 are longer than at least the parts of the first inner conductors 4a or the second inner conductors 4b of the cables 4 exposed from the dielectrics 4c thereof in the X-axis direction. In this way, crosstalk between cables 4 arranged side by side in the Y-axis direction can be suppressed.

Further, as shown in FIG. 5, the part of the ground shield 4d exposed from the insulating film 4e in the cable 4 is disposed between the first and second partition walls 12a and 12b of the first partitioning member 12, or between the second partition wall 12b of the first partitioning member 12 and the partition wall 13a of the second partitioning member 13 as viewed in the Z-axis direction.

Note that as shown in FIG. 5, the parts of the ground shields 4d exposed from the insulating films 4e in the cables 4 are preferably arranged side by side in the Y-axis direction. That is, the parts of the ground shields 4d exposed from the insulating films 4e in the cables 4 are preferably arranged at roughly the same position in the X-axis direction.

Further, as shown in FIG. 5, the parts of the ground shields 4d exposed from the insulating films 4e in the cables 4 are electrically connected to the ground member 3 (e.g., the partition walls on both sides of the cables 4 in the Y-axis direction) by a conductive material (e.g., solder 8). Note that in FIG. 5 and the like, the solder 8 is shown in a see-through manner so that the parts of the ground shields 4d exposed from the insulating films 4e in the cables 4 can be clearly shown.

In this way, ground paths extending from the ground shields 4d of the cables 4 to the ground contacts 2b of the paddle card 2 through the ground member 3 are formed. Note that as shown in FIG. 5, the parts of the ground shields 4d exposed from the insulating films 4e in the cables 4 arranged side by side in the Y-axis direction are preferably electrically connected to the ground member 3 by a conductive material (e.g., solder 8).

By electrically connecting the parts of the ground shields 4d exposed from the insulating films 4e in the cables 4 arranged side by side in the Y-axis direction as described above, the ground level can be maintained, so that the insertion loss can be stabilized. As a result, the transmission characteristic can be improved.

The cables 4 arranged side by side in the Y-axis direction are arranged in an orderly manner by the locator 5. For example, as shown in FIG. 2, the locator 5 is a cylindrical member having a roughly rectangular shape which is long in the Y-axis direction as viewed in the Z-axis direction, and has a width in the X-axis direction. Further, as shown in FIG. 5, on the inner periphery of the locator 5, positioning grooves 5a for the cables 4 are arranged side by side in the Y-axis direction.

As shown in FIG. 5, the cables 4 are passed through the locator 5 in the X-axis direction. In this way, the cables 4 are arranged in the Y-axis direction in conformity with the positioning grooves 5a. Note that as shown in FIG. 2, it is preferred that an opening 5b is formed in the part of the locator 5 on the inner side of the connector assembly 1 in the Z-axis direction, and the cables 4 and the locator 5 are fixed by applying an adhesive to the opening 5b.

As shown in FIG. 1, the housing 6 includes a first case 6a and a second case 6b. The first and second cases 6a and 6b are aligned and fixed to each other in the Z-axis direction so as to cover the connection parts between the paddle card 2 and the cables 4, the ground member 3, and the locator 5 with the end of the metal plate 11 on the Y-axis positive side and the end thereof on the Y-axis negative side being interposed therebetween in the Z-axis direction.

Therefore, as shown in FIG. 1, the paddle card 2 projects from the housing 6 toward the X-axis positive side, and the cables 4 project from the housing 6 toward the X-axis negative side. As shown in FIG. 1, for example, the housing 6 has a rectangular shape which is long in the Y-axis direction as viewed in the X-axis direction, and is preferably a rectangular box member which is long in the Y-axis direction as viewed in the Z-axis direction.

Note that as shown in FIG. 1, a female-mating part 6c into which the frame 7 is mated is preferably formed in a part of the housing 6 on the X-axis positive side thereof. The female-mating part 6c is formed, for example, by cutting out a peripheral part of the part of the housing 6 on the X-axis positive side thereof. However, the housing 6 may have any shape as long as it can cover at least the connection parts between the paddle card 2 and the cables 4, the ground member 3, and the locator 5.

The frame 7 is mated with the frame of a connector to be mated with the connector assembly 1. As shown in FIG. 1, for example, the frame 7 is a cylindrical member having a rectangular shape which is long in the Y-axis direction as viewed in the X-axis direction, and is mated with and fixed to the female-mating part 6c of the housing 6. The frame 7 is preferably made of, for example, metal.

Note that the connector assembly 1 according to this embodiment may include a lever member for engaging a connector to be mated therewith, a manipulation member for manipulating the lever member, and the like. However, they are not essential parts in the present disclosure and hence descriptions thereof are omitted.

Next, a flow for manufacturing a connector assembly 1 according to this embodiment will be described. Firstly, a ground member 3 is formed by fixing first partitioning members 12 and second partitioning members 13 to a metal plate 11. Note that the first partitioning members 12 can be easily positioned relative to the metal plate 11 by mating the connection parts 12f of the fixing parts 12d of the first partitioning members 12 into the recesses 11a of the metal plate 11.

Meanwhile, cables 4 are passed through a locator 5 and fixed thereto. Then, the first and second inner conductors 4a and 4b are exposed by stripping off the parts of dielectrics 4c, ground shields 4d, and insulating films 4e at the end of the cables 4 on the X-axis positive side. Further, the parts of the ground shields 4d are exposed by stripping off the ends of the insulating films 4e of the cables 4 on the X-axis positive side.

Next, in the X-axis direction, the ends of the first partition walls 12a of the first partitioning members 12 on the X-axis positive side in the ground member 3, the ends of the second partition walls 12b on the X-axis positive side therein, and the ends of the partition walls 13a of the second partitioning members 13 on the X-axis positive side therein are positioned so that they overlap the ground contacts 2b of the paddle card 2.

Next, the cables 4 are disposed between the first and second partition walls 12a and 12b of the first partitioning members 12 in the ground member 3, and between the second partition walls 12b of the first partitioning members 12 and the partition walls 13a of the second partitioning members 13.

Note that the cables 4 disposed between the first partitioning members 12, or between the first and second partitioning members 12 and 13 on the Z-axis positive side of the metal plate 11 are disposed so as to overlap the flat parts 12e of the fixing parts 12d of the first partitioning members 12 disposed on the Z-axis negative side of the metal plate 11 as viewed in the Z-axis direction.

Further, the cables 4 disposed between the first partitioning members 12, or between the first and second partitioning members 12 and 13 on the Z-axis negative side of the metal plate 11 are disposed so as to overlap the flat parts 12e of the fixing parts 12d of the first partitioning members 12 disposed on the Z-axis positive side of the metal plate 11 as viewed in the Z-axis direction.

Next, the ends of the first and second inner conductors 4a and 4b of the cables 4 on the X-axis positive side are disposed so as to overlap the signal contacts 2a of the paddle card 2 in the Z-axis direction.

Next, the parts of the ground shields 4d exposed from the insulating films 4e in the cables 4 are electrically connected to the ground member 3 by solder 8, and the ground shields 4d of the cables 4 arranged side by side in the Y-axis direction are electrically connected to each other.

Note that when the parts of the ground shields 4d exposed from the insulating films 4e in the cables 4 are arranged side by side in the Y-axis direction, the ground shields 4d of the cables 4 arranged side by side in the Y-axis direction can be easily connected to each other.

Next, the ends of the first and second inner conductors 4a and 4b of the cables 4 on the X-axis positive side are electrically connected to the signal contacts 2a of the paddle card 2. Note that since the signal contacts 2a of the paddle card 2 are arranged side by side in the Y-axis direction, the cables 4 can be easily connected to the paddle card 2.

Then, the ends of the first partition walls 12a of the first partitioning members 12 on the X-axis positive side in the ground member 3, the ends of the second partition walls 12b on the X-axis positive side therein, and the ends of the partition walls 13a of the second partitioning members 13 on the X-axis positive side therein are electrically connected to the ground contacts 2b of the paddle card 2. Note that since the ground contacts 2b of the paddle card 2 are arranged side by side in the Y-axis direction, the ground member 3 can be easily connected to the paddle card 2.

Next, while the end of the metal plate 11 on the Y-axis positive side and the end thereof on the Y-axis negative side are sandwiched by the housing 6, i.e., by the first and second cases 6a and 6b, in the Z-axis direction, the connection parts between the paddle card 2 and the cables 4, the ground member 3, and the locator 5 are covered by the housing 6. Then, by mating the frame 7 into the female-mating part 6c of the housing 6, a connector assembly 1 can be manufactured.

In the connector assembly 1 according to this embodiment, the ground member 3 is formed by fixing the first partitioning members 12, each of which has basically a roughly U-shape as viewed in the X-axis direction, to the metal plate 11 at a pitch twice the predetermined pitch, and the first and second partition walls 12a and 12b of the first partitioning members 12 are arranged side by side in the Y-axis direction. Further, the parts of the ground shields 4d exposed from the insulating films 4e in the cables 4 are electrically connected to the first partitioning members 12 in the state where they are disposed between the first and second partition walls 12a and 12b of the first partitioning members 12. Therefore, in the connector assembly 1 according to this embodiment, it is possible to arrange the positions of the ground connections roughly in a straight line in the Y-axis direction, and thereby to reduce the size of the connector assembly 1 compared with the connector assembly disclosed in Patent Literature 1.

Further, in the connector assembly 1 according to this embodiment, the first partitioning members 12 of the ground member 3 are electrically connected to the ground contacts 2b of the paddle card 2. Therefore, ground paths extending from the ground shields 4d of the cables 4 to the ground contacts 2b of the paddle card 2 through the ground member 3 are formed.

Owing to the above-described features, the size of the connector assembly 1 according to this embodiment, in which ground paths are formed between the cables 4 and the paddle card 2, can be reduced compared with the connector assembly disclosed in Patent Literature 1.

In the connector assembly 1 according to this embodiment, the ground member 3 includes the metal plate 11, so that the thickness of the metal plate 11 can be changed as appropriate according to the thickness of the paddle card 2.

In the connector assembly 1 according to this embodiment, when the first partitioning members 12 arranged on the Z-axis positive side of the metal plate 11 and the first partitioning members 12 arranged on the Z-axis negative side of the metal plate 11 are staggered, i.e., alternately disposed, in the Y-axis direction as viewed in the X-axis direction, first partitioning members 12 adjacent to each other in the Y-axis direction can be arranged close to each other (i.e., the distance between first partitioning members 12 adjacent to each other can be reduced). Therefore, the size of the connector assembly 1 can be further reduced.

In the connector assembly 1 according to this embodiment, the first and second partition walls 12a and 12b of the first partitioning members 12 cover the cables 4 from the position on the X-axis negative side of the parts of the ground shields 4d exposed from the insulating films 4e of the cables 4 to the position beyond, on the X-axis positive side, the ends of the first and second inner conductors 4a and 4b of the cables 4 on the X-axis positive side. In this way, crosstalk between cables 4 arranged side by side in the Y-axis direction can be suppressed. That is, crosstalk between channels can be suppressed, so that the transmission performance can be improved.

In the connector assembly 1 according to this embodiment, when the parts of the ground shields 4d exposed from the insulating films 4e in the cables 4 arranged side by side in the Y-axis direction are electrically connected to each other, the ground level can be maintained, so that the insertion loss can be stabilized. As a result, the transmission characteristic can be improved. Further, when the parts of the ground shields 4d exposed from the insulating films 4e in the cables 4 are arranged side by side in the Y-axis direction, the ground shields 4d of the cables 4 arranged side by side in the Y-axis direction can be easily connected to each other.

In the connector assembly 1 according to this embodiment, when the first partitioning members 12 includes the fixing parts 12d, the first partitioning members 12 can be easily positioned relative to the metal plate 11 by mating the connection parts 12f of the fixing parts 12d of the first partitioning members 12 into the recesses 11a of the metal plate 11.

Note that although the connector assembly 1 according to this embodiment includes the second partitioning members 13, the second partitioning members 13 may not be provided, i.e., may not be necessary, depending on the number of cables 4.

### Second Embodiment

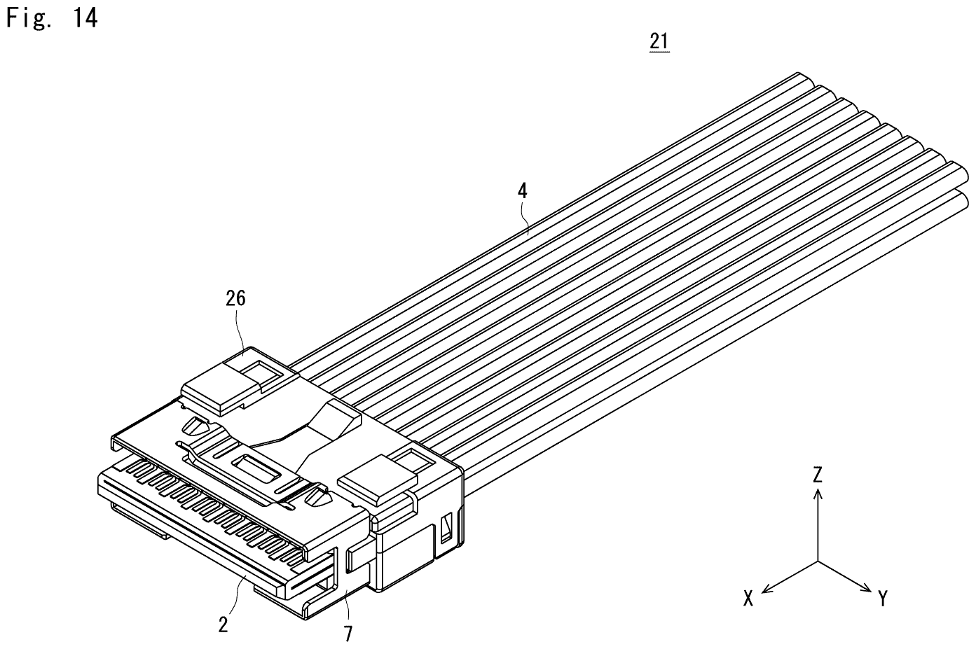

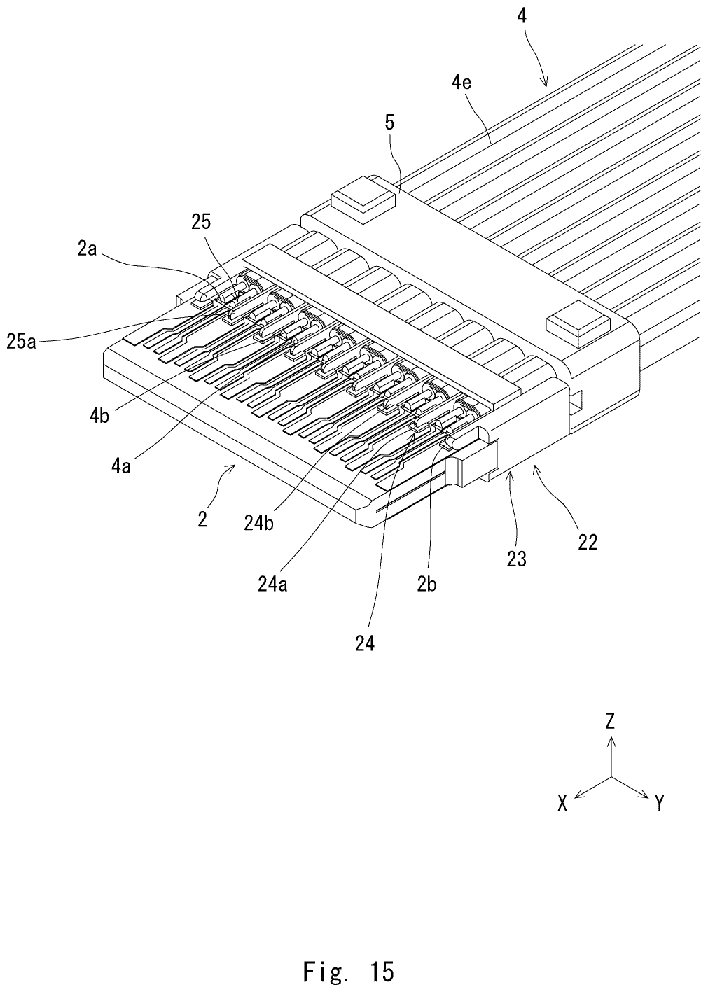

FIG. 14 is a perspective view of a connector assembly according to this embodiment viewed from the Z-axis positive side. FIG. 15 is a perspective view of the connector assembly according to this embodiment viewed from the Z-axis positive side, in which a housing and a frame are omitted (i.e., are not drawn).

As shown in FIGS. 14 and 15, the connector assembly 21 according to this embodiment has a configuration roughly identical to that of the connector assembly 1 according to the first embodiment, but the configuration of a ground member 22 differs from that of the ground member 3 of the connector assembly 1. Therefore, redundant descriptions will be omitted and the configuration of the ground member 22 will be mainly described.

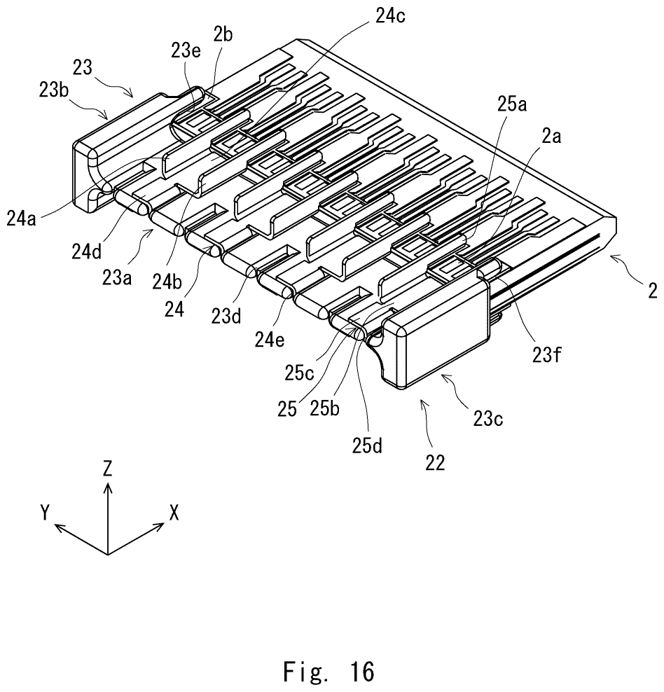

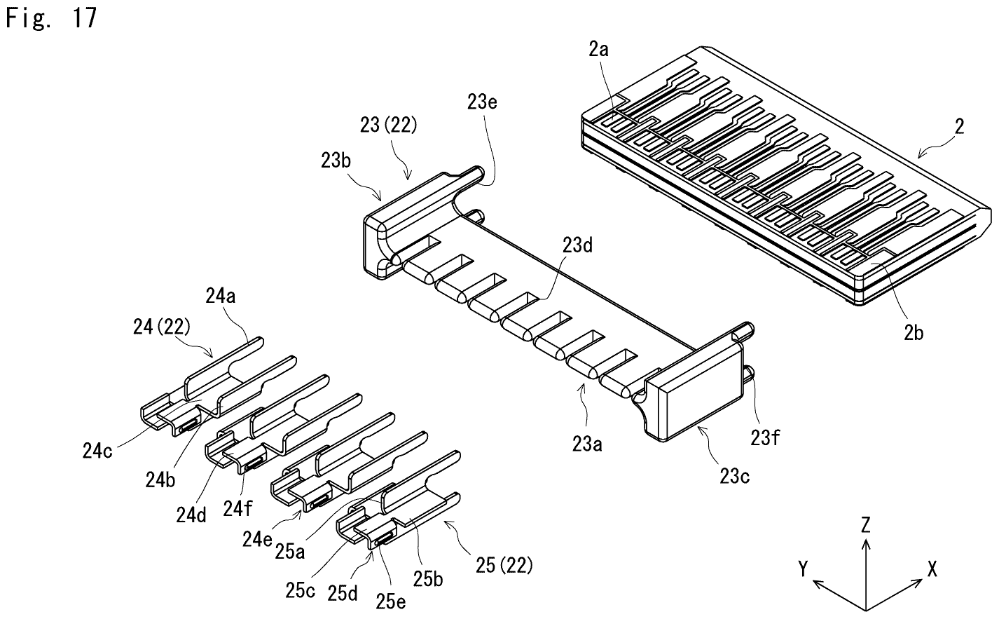

FIG. 16 is a perspective view of a paddle card and a ground member in the connector assembly according to this embodiment viewed from the Z-axis positive side. FIG. 17 is an exploded perspective view of the paddle card and the ground member in the connector assembly according to this embodiment viewed from the Z-axis positive side.

As shown in FIGS. 16 and 17, the ground member 22 includes a metal member 23, first partitioning members 24, and second partitioning members 25. The metal member 23 is a cut article or a molded article made of metal (e.g., a metal injection-molded article). The metal member 23 includes, for example, a flat part 23a, a first sidewall part 23b, and a second sidewall part 23c.

As shown in FIGS. 16 and 17, the flat part 23a is a plate member disposed roughly parallel to the XY-plane, and preferably has, for example, a roughly rectangular shape which is long in the Y-axis direction as viewed in the Z-axis direction. Recesses 23d are formed at the end of the flat part 23a on the X-axis negative side at a predetermined pitch. In this embodiment, for example, an even number of recesses 23d are arranged in the Y-axis direction according to the number of cables 4 arranged side by side in the Y-axis direction.

As shown in FIGS. 16 and 17, the first sidewall part 23b is fixed to the end of the flat part 23a on the Y-axis positive side. The first sidewall part 23b is a plate member disposed roughly parallel to the XZ-plane, and preferably has, for example, a roughly rectangular shape which is long in the X-axis direction as viewed in the Y-axis direction. Further, a cut-out part 23e is formed in the part of the first sidewall part 23b projecting from the flat part 23a toward the X-axis positive side.

As shown in FIGS. 16 and 17, the cut-out part 23e has such a shape that the end of the paddle card 2 on the X-axis negative side can be inserted into the cut-out part 23e. The cut-out part 23e is, for example, roughly rectangular as viewed in the Y-axis direction, and extends in the X-axis direction and reaches the end of the first sidewall part 23b on the X-axis positive side. Further, the height of the cut-out part 23e in the Z-axis direction is roughly equal to the thickness of the paddle card 2 in the Z-axis direction.

As shown in FIGS. 16 and 17, the second sidewall part 23c is fixed to the end of the flat part 23a on the Y-axis negative side. The second sidewall part 23c has a shape roughly identical to that of the first sidewall part 23b as viewed in the Y-axis direction, and a cut-out part 23f is formed in the second sidewall part 23c.

As shown in FIGS. 16 and 17, the first and second partitioning members 24 and 25 are arranged on both the Z-axis positive side and the Z-axis negative side of the flat part 23a of the metal member 23. Note that the first and second partitioning members 24 and 25 disposed on the Z-axis positive side of the flat part 23a of the metal member 23 and the first and second partitioning members 24 and 25 disposed on the Z-axis negative side of the flat part 23a of the metal member 23 are in a point-symmetric relationship with an axis that passes through the center of the connector assembly 21 in the Y-axis direction and is parallel to the X-axis being the axis of symmetry. Therefore, the shapes and arrangements of the first and second partitioning members 24 and 25 arranged on the Z-axis positive side of the flat part 23a of the metal member 23 will be described hereinafter as a representative example.

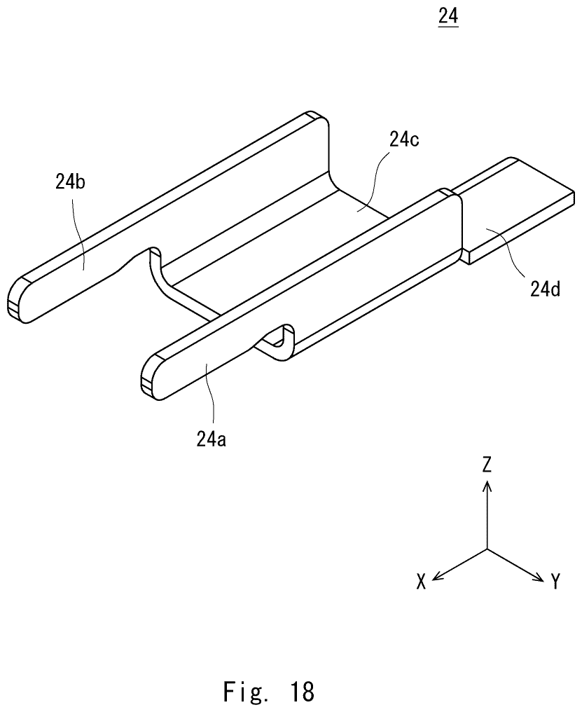

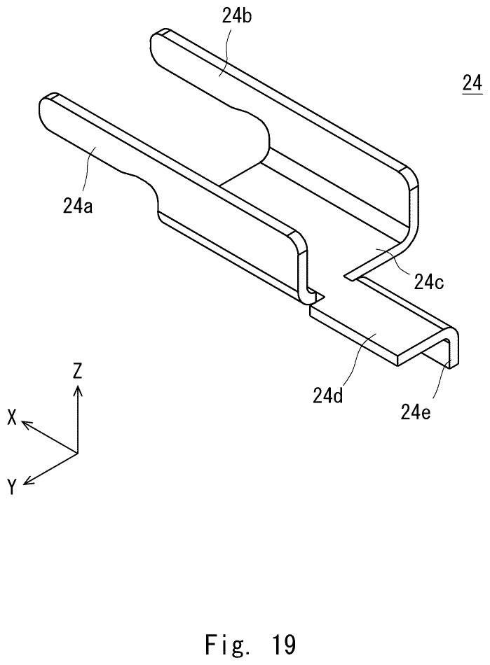

FIG. 18 is a perspective view of a representative first partitioning member of the ground member in the connector assembly according to this embodiment viewed from the Z-axis positive side. FIG. 19 is another perspective view of the representative first partitioning member of the ground member in the connector assembly according to this embodiment viewed from the Z-axis positive side.

As shown in FIGS. 18 and 19, the first partitioning member 24 (i.e., each of the first partitioning members 24) includes a first partition wall 24a, a second partition wall 24b, a flat part 24c, an extension part 24d, and a press-fitting part 24e. The first partition wall 24a, the second partition wall 24b, and the flat part 24c have shapes roughly identical to those of the first partition wall 12a, the second partition wall 12b, and the flat part 12c, respectively, of the first partitioning member 12 in the first embodiment.

As shown in FIGS. 18 and 19, the extension part 24d projects from the flat part 24c toward the X-axis negative side. The extension part 24d is a plate member disposed roughly parallel to the XY-plane, and preferably has, for example, a roughly rectangular shape which is long in the X-axis direction as viewed in the Z-axis direction. The press-fitting part 24e projects from the end of the flat part 24c on the Y-axis negative side toward the Z-axis negative side.

As shown in FIGS. 18 and 19, the press-fitting part 24e is a plate member disposed roughly parallel to the XZ-plane, and preferably has, for example, a roughly rectangular shape which is long in the X-axis direction as viewed in the Y-axis direction. The thickness of the press-fitting part 24e in the Y-axis direction is preferably roughly equal to the width of the recess 23d of the flat part 23a of the metal member 23 in the Y-axis direction. The press-fitting part 24e is disposed roughly at the center of the first partitioning member 24 in the Y-axis direction.

Further, as shown in FIGS. 16 and 17, in the state where the first and second partition walls 24a and 24b of the first partitioning members 24 project from the flat part 24c toward the Z-axis positive side, the press-fitting parts 24e are press-fitted from the X-axis negative side into, among the recesses 23d of the metal member 23, the even-numbered recesses 23d counted from the Y-axis positive side, except for the recess 23d on the Y-axis negative side.

As a result, as shown in FIG. 16, the first partitioning members 24 are fixed to the metal member 23 in the state where the first partition walls 24a, the second partition walls 24b, and the flat parts 24c of the first partitioning members 24 are disposed on the Z-axis positive side of the flat part 23a of the metal member 23.

Note that as shown in FIG. 16, the first partitioning members 24 are arranged at a pitch twice the predetermined pitch in the Y-axis direction, and the first and second partition walls 24a and 24b are arranged at the predetermined pitch in a repeated manner in the Y-axis direction.

Note that as described above, the first partitioning members 24 disposed on the Z-axis positive side of the flat part 23a of the metal member 23 and the first partitioning members 24 disposed on the Z-axis negative side of the flat part 23a of the metal member 23 are in the point-symmetric relationship.

Therefore, as shown in FIG. 17, as viewed in the X-axis direction, the first partitioning members 24 disposed on the Z-axis positive side of the flat part 23a of the metal member 23 and the first partitioning members 24 disposed on the Z-axis negative side of the flat part 23a of the metal member 23 staggered, i.e., alternately disposed, in the Y-axis direction.

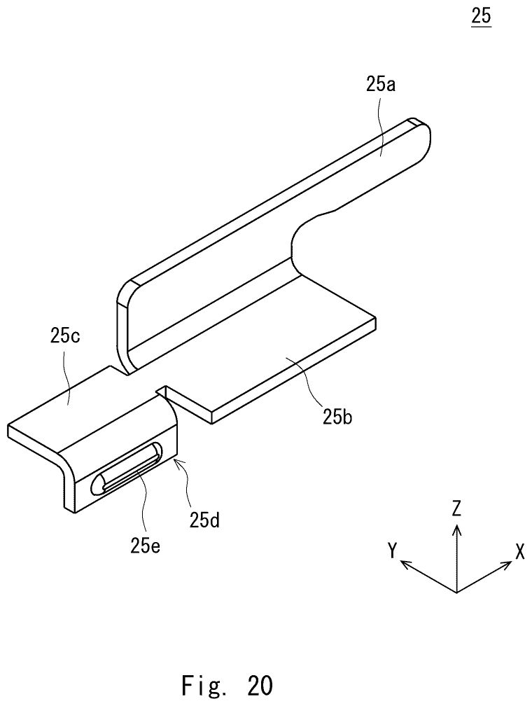

FIG. 20 is a perspective view of a representative second partitioning member in the connector assembly according to this embodiment viewed from the Z-axis positive side. As shown in FIG. 20, the second partitioning member 25 (i.e., each of the second partitioning members 25) includes a partition wall 25a, a flat part 25b, an extension part 25c, and a press-fitting part 25d. The partition wall 25a and the flat part 25b have shapes roughly identical to those of the partition wall 13a and the flat part 13b, respectively, of the second partitioning member 13 in the first embodiment.

As shown in FIG. 20, the extension part 25c and the press-fitting part 25d have shapes roughly identical to those of the extension part 24d and the press-fitting part 24e, respectively, of the first partitioning member 24, and project from the flat part 23a toward the X-axis negative side. The press-fitting part 25d is disposed roughly at the center of the second partitioning member 25 in the Y-axis direction.

Further, as shown in FIGS. 16 and 17, in the state where the partition walls 25a of the second partitioning members 25 project from the flat parts 25b toward the Z-axis positive side, the press-fitting parts 25d are press-fitted from the X-axis negative side into the recesses 23d of the metal member 23 on the Y-axis negative side.

As a result, as shown in FIG. 16, the first partition wall 24a of the first partitioning members 24, the second partition wall 24b of the first partitioning members 24, and the partition walls 25a of the second partitioning members 25 are arranged at the predetermined pitch in the Y-axis direction on the Z-axis positive side of the flat part 23a of the metal member 23.

Further, as shown in FIG. 16, the first partition wall 24a of the first partitioning members 24, the second partition wall 24b of the first partitioning members 24, and the partition walls 25a of the second partitioning members 25 are also arranged at the predetermined pitch in the Y-axis direction on the Z-axis negative side of the flat part 23a of the metal member 23.

Note that as shown in FIG. 17, projections 24f projecting in the Y-axis direction are preferably formed in the press-fitting parts 24e of the first partitioning members 24, and projections 25e projecting in the Y-axis direction are preferably formed in the press-fitting parts 25d of the second partitioning members 25.

In this way, when the press-fitting parts 24e of the first partitioning members 24 and the press-fitting parts 25d of the second partitioning members 25 are press-fitted into the recesses 23d of the flat part 23a of the metal member 23, the first and second partitioning members 24 and 25 can be firmly fixed to the metal member 23.

As shown in FIGS. 15 and 16, the ground member 22 described above is fixed to the paddle card 2 in the state where the paddle card 2 is inserted into the cut-out parts 23e of the first sidewall parts 23b and the cut-out parts 23f of the second sidewall parts 23c of the metal member 23.

Further, as shown in FIG. 15, the first and second sidewall parts 23b and 23c of the metal member 23 are electrically connected to the ground contacts 2b of the paddle card 2. Further, the first and second partition walls 24a and 24b of the first partitioning members 24, and the partition walls 25a of the second partitioning members 25 are also electrically connected to the ground contacts 2b of the paddle card 2.

Further, as shown in FIG. 15, the first and second inner conductors 4a and 4b of the cables 4 disposed between the first and second partition walls 24a and 24b of the first partitioning members 24 in the ground member 22, and between the second partition walls 24b of the first partitioning members 24 and the partition walls 25a of the second partitioning members 25 are electrically connected to the signal contacts 2a of the paddle card 2.

Note that as shown in FIG. 15, as viewed in the Y-axis direction, the first and second partition walls 24a and 24b of the first partitioning members 24 and the partition walls 25a of the second partitioning members 25 cover the cables 4 from the position on the X-axis negative side of the parts of the ground shields 4d exposed from the insulating films 4e of the cables 4 to the position beyond, on the X-axis positive side, the ends of the first and second inner conductors 4a and 4b of the cables 4 on the X-axis positive side. That is, the first and second partition walls 24a and 24b of the first partitioning member 24 and the partition wall 25a of the second partitioning member 25 are longer than at least the parts of the first inner conductors 4a or the second inner conductors 4b of the cables 4 exposed from the dielectrics 4c thereof in the X-axis direction.

Note that as described above, the configuration of the ground member 22 of the connector assembly 21 according to this embodiment differs from that of the ground member 3 of the connector assembly 1 according to the first embodiment. Therefore, unlike the housing 6 of the connector assembly 1 according to the first embodiment, the housing 26 is preferably configured so as to cover the metal member 23 of the ground member 22 as shown in FIG. 14.

In the connector assembly 21 according to this embodiment, the ground member 22 is formed by fixing the first partitioning members 24, each of which has basically a roughly U-shape as viewed in the X-axis direction, to the metal member 23 at a pitch twice the predetermined pitch, and the first and second partition walls 24a and 24b of the first partitioning members 24 are arranged side by side in the Y-axis direction. Further, the parts of the ground shields 4d exposed from the insulating films 4e in the cables 4 are electrically connected to the first partitioning members 24 in the state where they are disposed between the first and second partition walls 24a and 24b of the first partitioning members 24. Therefore, in the connector assembly 21 according to this embodiment, it is also possible to arrange the positions of the ground connections roughly in a straight line in the Y-axis direction, and thereby to reduce the size of the connector assembly 21 compared with the connector assembly disclosed in Patent Literature 1.

Further, in the connector assembly 21 according to this embodiment, the ground member 22 is electrically connected to the ground contacts 2b of the paddle card 2. Therefore, ground paths extending from the ground shields 4d of the cables 4 to the ground contacts 2b of the paddle card 2 through the ground member 22 are formed.

Owing to the above-described features, the size of the connector assembly 21 according to this embodiment, in which ground paths are formed between the cables 4 and the paddle card 2, can also be reduced compared with the connector assembly disclosed in Patent Literature 1.

### Third Embodiment

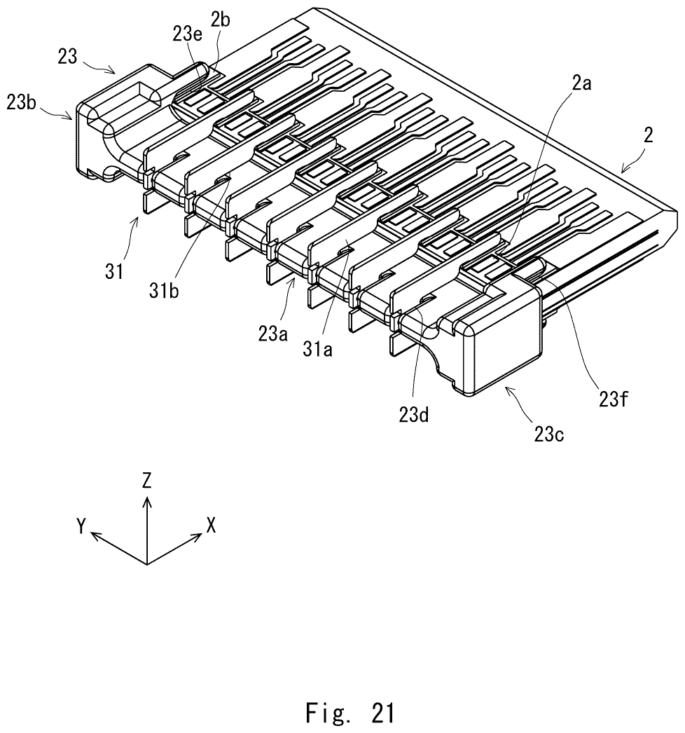

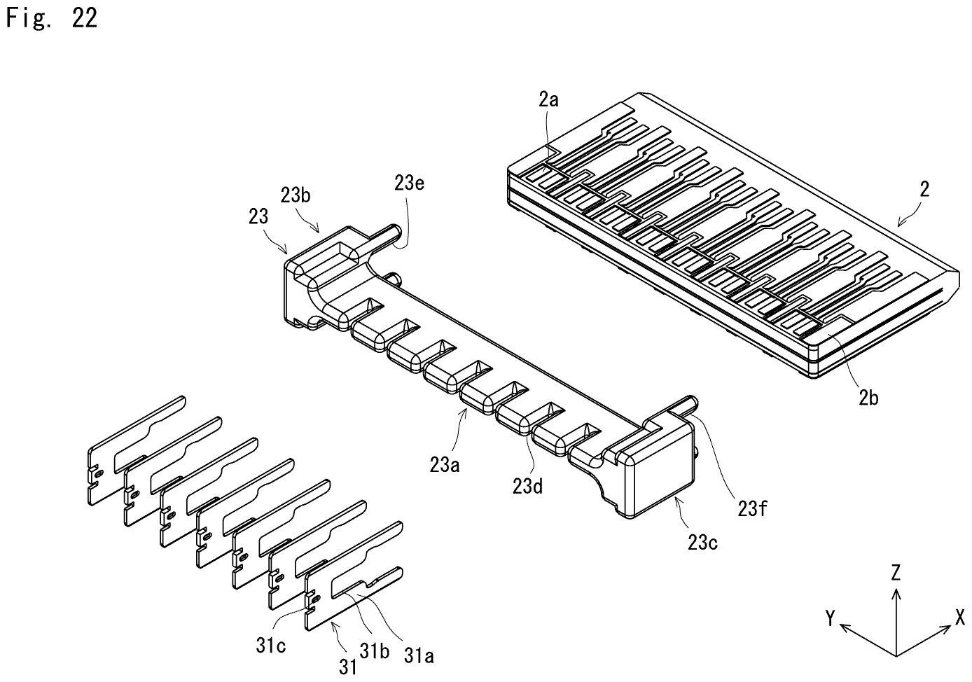

FIG. 21 is a perspective view of a paddle card and a ground member in a connector assembly according to this embodiment viewed from the Z-axis positive side. FIG. 22 is an exploded perspective view of the paddle card and the ground member in the connector assembly according to this embodiment viewed from the Z-axis positive side.

Although the ground member 22 of the connector assembly 21 according to the second embodiment uses the first and second partitioning members 24 and 25, plate-like partitioning members 31 may be used in place of the first and second partitioning members 24 and 25 as shown in FIGS. 21 and 22.

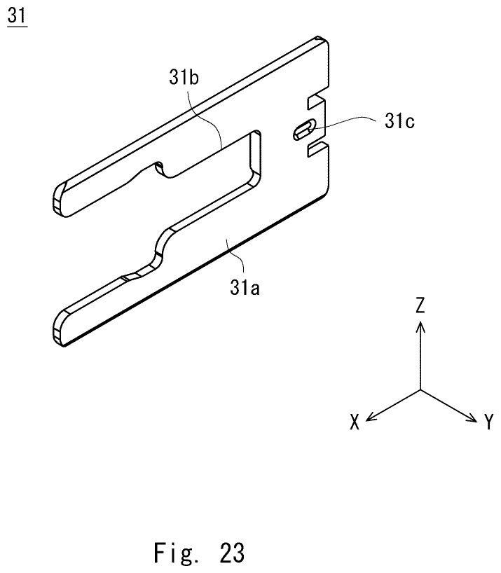

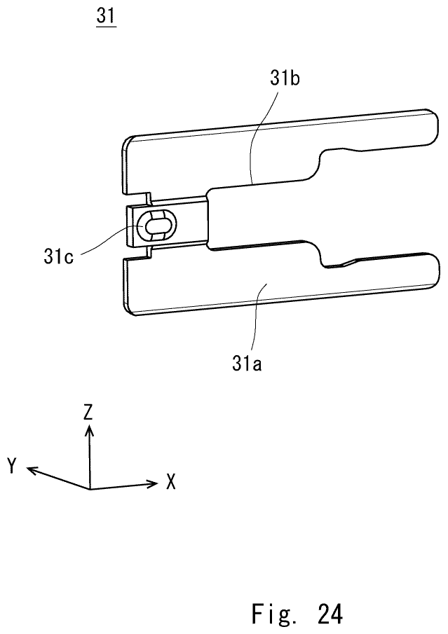

FIG. 23 is a perspective view of a partitioning member of the ground member according to this embodiment viewed from the Z-axis positive side. FIG. 24 is another perspective view of the partitioning member of the ground member according to this embodiment viewed from the Z-axis positive side. As shown in FIGS. 23 and 24, the partitioning member 31 (i.e., each of the partitioning members 31) is a plate member disposed roughly parallel to the XZ-plane.

The thickness of the partitioning member 31 in the Y-axis direction is preferably roughly equal to the width of the recess 23d of the flat part 23a of the metal member 23 in the Y-axis direction. Further, as shown in FIGS. 23 and 24, the partitioning member 31 has preferably a roughly U-shape as viewed in the Y-axis direction. That is, the partitioning member 31 includes a partition wall 31a and a cut-out part 31b.

As shown in FIGS. 23 and 24, for example, the cut-out part 31b is an X-axis negative-side part of a roughly rectangular two-step recess which is long in the X-axis direction. The height of the cut-out part 31b in the Z-axis direction is roughly equal to the thickness of the flat part 23a of the metal member 23 in the Z-axis direction.

Further, as shown in FIG. 21, in the state where the flat part 23a of the metal member 23 is passed through the cut-out part 31b of the partitioning member 31 from the X-axis negative side, the part of the partitioning member 31 on the X-axis negative side of the cut-out part 31b is press-fitted into the recess 23d of the flat part 23a. That is, the part of the partitioning member 31 on the X-axis negative side of the cut-out part 31b functions as a press-fitting part.

Note that as shown in FIG. 21, the end of the partitioning member 31 on the X-axis positive side projects from the flat part 23a of the metal member 23 toward the X-axis positive side. Further, similarly to the first and second partition walls 24a and 24b of the first partitioning members 24 and the partition walls 25a of the second partitioning members 25 in the second embodiment, the parts of the partitioning members 31 on the Z-axis positive side of the cut-out parts 31b and the parts of the partitioning members 31 on the Z-axis negative side of the cut-out parts 31b are arranged, as partition walls 31a, at the predetermined pitch in the Y-axis direction on the Z-axis positive side and the Z-axis negative side of the flat part 23a of the metal member 23.

The cables 4 are disposed between the partition walls 31a of the partitioning members 31 described above, and the first and second inner conductors 4a and 4b of the cables 4 are electrically connected to the signal contacts 2a of the paddle card 2. Note that as viewed in the Y-axis direction, the partition walls 31a of the partitioning members 31 cover the cables 4 from the position on the X-axis negative side of the parts of the ground shields 4d exposed from the insulating films 4e of the cables 4 to the position beyond, on the X-axis positive side, the ends of the first and second inner conductors 4a and 4b of the cables 4 on the X-axis positive side. That is, the partition walls 31a of the partitioning members 31 are longer than at least the parts of the first inner conductors 4a or the second inner conductors 4b of the cables 4 exposed from the dielectrics 4c thereof in the X-axis direction.

Note that as shown in FIGS. 23 and 24, projections 31c projecting in the Y-axis direction are preferably formed in the parts of the partitioning members 31 located on the X-axis negative side of the cut-out parts 31b. In this way, when the parts of the partitioning members 31 located on the X-axis negative side of the cut-out parts 31b are press-fitted into the recesses 23d of the flat part 23a of the metal member 23, the partitioning members 31 can be firmly fixed to the metal member 23.

The partitioning members 31 in this embodiment described above can be formed more easily than the first and second partitioning members 12 and 13 in the first embodiment and the first and second partitioning members 24 and 25 in the second embodiment. Further, the size of the connector assembly according to this embodiment, in which ground paths are formed between the cables 4 and the paddle card 2, can also be reduced compared with the connector assembly disclosed in Patent Literature 1.

The present disclosure is not limited to the above-described embodiments, and they can be modified as appropriate without departing from the scope and spirit of the disclosure.

For example, the connector assemblies 1 and 21 according to the above-described embodiments both include the frame 7, but it may not be provided, i.e., may not be necessary, depending on the shapes of the connectors to which the connector assemblies 1 and 21 are mated. Further, the locator 5 may not be provided, i.e., may not be necessary.

For example, the shape of the partitioning member in any of the above-described embodiments is merely an example and, for example, the fixing part and the press-fitting part may not be provided, i.e., may not be necessary.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A connector assembly comprising a paddle card comprising a plurality of contacts, and a plurality of cables electrically connected to the plurality of contacts, wherein
the connector assembly further comprises a ground member comprising:
a plurality of partitioning members made of metal, each of the plurality of partitioning members having a U-shape as viewed in an insertion and removal direction of the connector assembly; and
a metal plate to which the partitioning members are fixed,
the ground member is configured such that the partitioning members are arranged at a pitch twice a predetermined pitch in a width direction of the connector assembly, so that the partition walls disposed on both sides of the partitioning members in the width direction of the connector assembly are arranged at the predetermined pitch in the width direction of the connector assembly,
each of the cables comprises an inner conductor electrically connected to a contact of the paddle card, a dielectric covering the inner conductor, a ground shield covering the dielectric, and an insulating film covering the ground shield, and
the ground shields are electrically connected to the ground member in a state where parts of the ground shields exposed from the insulating films in the cables are disposed between the partition walls.

2. The connector assembly according to claim 1, wherein
the contacts are disposed on both surfaces of the paddle card in a thickness direction,
the cables are disposed on both sides of the metal plate in the thickness direction so as to be electrically connected to the contacts disposed on the respective surfaces of the paddle card,
the partitioning members are disposed on both sides of the metal plate in the thickness direction, and
the partitioning members disposed on one of the sides of the metal plate in the thickness direction and the partitioning members disposed on the other side of the metal plate in the thickness direction are staggered in the width direction of the connector assembly as viewed in an insertion and removal direction of the connector assembly.

3. The connector assembly according to claim 2, wherein
each of the partitioning members comprises a fixing part,
the fixing part has such a shape that the metal plate can be interposed by the fixing part as viewed in the width direction of the connector assembly, and
the cables disposed between the partitioning members are electrically connected, in the thickness direction of the connector assembly, to the fixing parts of the partitioning members disposed on a side of the metal plate opposite to a side thereof on which the cables disposed between the partitioning members are disposed in the thickness direction of the connector assembly.

4. The connector assembly according to claim 1, wherein each of the partition walls is longer than a part of the inner conductor of each of the cables exposed from the dielectric in the insertion and removal direction of the connector assembly.

5. The connector assembly according to claim 1, wherein the partitioning members are electrically connected and fixed to the metal plate.

6. The connector assembly according to claim 1, wherein parts of the ground shields exposed from the insulating films in the cables are arranged side by side in the width direction of the connector assembly.

7. The connector assembly according to claim 1, further comprising a locator disposed on a side of the partitioning members opposite to a side thereof on which the paddle card is located, wherein
the plurality of cables are arranged in the width direction of the connector assembly in an orderly manner by the locator.

8. The connector assembly according to claim 1, wherein a pair of differential signal lines is included in the plurality of cables.

9. A connector assembly comprising a paddle card comprising a plurality of contacts, and a plurality of cables electrically connected to the plurality of contacts, wherein
the connector assembly further comprises a ground member comprising:
a plurality of partitioning members made of metal, each of the plurality of partitioning members having a U-shape as viewed in an insertion and removal direction of the connector assembly; and
a metal member comprising a flat part to which the partitioning members are fixed, the metal member being a cut article or a molded article made of metal,
the ground member is configured such that the partitioning members are arranged at a pitch twice a predetermined pitch in a width direction of the connector assembly, so that the partition walls disposed on both sides of the partitioning members in the width direction of the connector assembly are arranged at the predetermined pitch in the width direction of the connector assembly,
each of the cables comprises an inner conductor electrically connected to a contact of the paddle card, a dielectric covering the inner conductor, a ground shield covering the dielectric, and an insulating film covering the ground shield, and
the ground shields are electrically connected to the ground member in a state where parts of the ground shields exposed from the insulating films in the cables are disposed between the partition walls.

10. The connector assembly according to claim 9, wherein
the contacts are disposed on both sides of the paddle card in a thickness direction,
the cables are disposed on both surfaces of the flat part of the metal member in the thickness direction so as to be electrically connected to the contacts disposed on the respective surfaces of the paddle card,
the partitioning members are disposed on both sides of the flat part of the metal member in the thickness direction, and
the partitioning members disposed on one of the sides of the flat part of the metal member in the thickness direction and the partitioning members disposed on the other side of the flat part of the metal member in the thickness direction are staggered in the width direction of the connector assembly as viewed in an insertion and removal direction of the connector assembly.

11. The connector assembly according to claim 9, wherein
the ground member is configured such that a plurality of plate-like partitioning members, instead of the partitioning members made of metal and having the U-shape, are arranged at the predetermined pitch in the width direction of the connector assembly by fixing the plate-like partitioning members to the flat part of the metal member at the predetermined pitch, and
the ground shields are electrically connected to the ground member in a state where the parts of the ground shields exposed from the insulating films in the cables are disposed between the plate-like partitioning members.

12. The connector assembly according to claim 9, wherein each of the partitioning members is longer than a part of the inner conductor of each of the cables exposed from the dielectric in the insertion and removal direction of the connector assembly.

13. The connector assembly according to claim 9, wherein each of the partitioning members comprises a press-fitting part configured to be press-fitted into a recess formed in the flat part of the metal member.

14. The connector assembly according to claim 9, wherein the parts of the ground shields exposed from the insulating films in the cables are arranged side by side in the width direction of the connector assembly.

15. The connector assembly according to claim 9, further comprising a locator disposed on a side of the partitioning members opposite to a side thereof on which the paddle card is located, wherein
the plurality of cables are arranged in the width direction of the connector assembly in an orderly manner by the locator.

16. The connector assembly according to claim 9, wherein a pair of differential signal lines is included in the plurality of cables.
